(19) United States
(12) Patent Application Publication
(10) Pub. No.: US 2012/0250460 A1
(43) Pub. Date: Oct. 4, 2012

(54) NOISE ATTENUATION USING ROTATION DATA

(76) Inventors: Pascal Edme, Cambridge (GB); Julian Edward Kragh, Finchingfield (GB); Everhard Muyzert, Cambridge (GB)

(21) Appl. No.: 13/208,860

(22) Filed: Aug. 12, 2011

Related U.S. Application Data
(60) Provisional application No. 61/471,363, filed on Apr. 4, 2011.

(51) Int. Cl. G01V 1/36

(52) U.S. Cl. 367/45

(57) ABSTRACT

Measured seismic data is received from a seismic sensor. Rotation data is also received, where the rotation data represents rotation with respect to at least one particular axis. The rotation data is combined, using adaptive filtering, with the measured seismic data to attenuate at least a portion of a noise component from the measured seismic data.

### CROSS REFERENCE TO RELATED APPLICATIONS

This application claims the benefit under 35 U.S.C. §119(e) of U.S. Provisional Application Ser. No. 61/471,363 entitled “Method for Noise Removal Using Rotational Sensor,” filed Apr. 4, 2011, which is hereby incorporated by reference.

### BACKGROUND

Seismic surveying is used for identifying subterranean elements, such as hydrocarbon reservoirs, freshwater aquifers, gas injection zones, and so forth. In seismic surveying, seismic sources are placed at various locations on a land surface or seafloor, with the seismic sources activated to generate seismic waves directed into a subterranean structure.

The seismic waves generated by a seismic source travel into the subterranean structure, with a portion of the seismic waves reflected back to the surface for receipt by seismic sensors (e.g. geophones, accelerometers, etc.). These seismic sensors produce signals that represent detected seismic waves. Signals from the seismic sensors are processed to yield information about the content and characteristic of the subterranean structure.

A typical land-based seismic survey arrangement includes deploying an array of seismic sensors on the ground. Marine surveying typically involves deploying seismic sensors on a streamer or seabed cable.

### SUMMARY

In general, according to some embodiments, a method includes receiving, from a seismic sensor, measured seismic data, and receiving rotation data representing rotation with respect to at least one particular axis. The rotation data is combined, using adaptive filtering, with the measured seismic data to attenuate at least a portion of a noise component from the measured seismic data.

In general, according to further embodiments, an article comprising at least one machine-readable storage medium stores instructions that upon execution cause a system having a processor to receive seismic data measured by a seismic sensor, receive rotation data representing rotation with respect to at least one particular axis, and combine, using adaptive filtering, the received seismic data and the received rotation data to attenuate at least a portion of a noise component from the received seismic data.

In general, according to yet other embodiments, a system includes a storage medium to store seismic data measured by a seismic sensor and rotation data, and at least one processor to apply adaptive filtering to combine the seismic data and the rotation data to remove at least a portion of a noise component in the seismic data.

In alternative or further implementations, the rotation data is measured by a rotational sensor.

In alternative or further implementations, the combining combines the rotation data individually received from the rotational sensor with the seismic data individually received from the seismic sensor to attenuate at least the portion of the noise component.

In alternative or further implementations, the rotation data is estimated from measurements of at least two seismic sensors that are spaced apart by less than a predetermined distance.

In alternative or further implementations, a rotation component with respect to a first axis and a rotation component with respect to a second axis generally perpendicular to the first axis are received.

In alternative or further implementations, the rotation data is based on measurement of a second sensor, where the second sensor is co-located with the seismic sensor within a housing, or the second sensor is spaced from the seismic sensor by less than a predetermined distance.

In alternative or further implementations, the adaptive filtering uses the rotation data to provide a noise reference for adaptive subtraction from the seismic data.

In alternative or further implementations, the adaptive subtraction is time-offset variant.

In alternative or further implementations, the adaptive subtraction is frequency dependent.

In alternative or further implementations, divergence data is received from a divergence sensor, and the adaptive filtering further combines the divergence data and the rotation data with the seismic data to attenuate at least the portion of the noise component.

In alternative or further implementations, horizontal component seismic data is received, and the adaptive filtering further combines the horizontal component seismic data and the rotation data with the seismic data to attenuate at least the portion of the noise component.

In alternative or further implementations, the seismic data is measured along the vertical axis and includes vertical component seismic data, and the adaptive filtering further combines one or more components of the rotation data measured around a horizontal axis with the vertical component seismic data to attenuate at least the portion of the noise component.

In alternative or further implementations, the noise component includes a horizontally travelling wave.

In alternative or further implementations, the seismic data includes one or more of a vectorial component in a vertical direction, a vectorial component in a first horizontal direction, and a vectorial component in a second horizontal direction that is generally perpendicular to the first horizontal direction, and the rotation data includes one or more of a first rotation component with respect to the vertical direction, a second rotation component with respect to the first horizontal direction, and a third rotation component with respect to the second horizontal direction.

In alternative or further implementations, the adaptive filtering includes computing at least one matching filter that is to attenuate, in a least square sense, noise in the seismic data over a given time window.

In alternative or further implementations, data conditioning is applied to the rotation data to improve noise correlation.

In alternative or further implementations, attenuation of at least the portion of the noise component is based on the seismic data and the rotation data from just an individual sensor station, which allows the noise attenuation to be performed without having to receive seismic data from other sensor stations that are part of a pattern of sensor stations.

In alternative or further implementations, the sensor station is spaced apart from another sensor station by a distance larger than have a shortest wavelength of noise.

In alternative or further implementations, the rotation data includes rotation fields with respect to plural horizontal directions.

Other or alternative features will become apparent from the following description, from the drawings, and from the claims.

### BRIEF DESCRIPTION OF THE DRAWINGS

Some embodiments are described with respect to the following figures:

FIG. 1 is a schematic diagram of an example arrangement of sensor assemblies that can be deployed to perform seismic surveying, according to some embodiments;

FIGS. 2 and 3 are schematic diagrams of sensor assemblies according to various embodiments; and

FIGS. 4-6 are flow diagrams of processes of noise attenuation according to various embodiments.

### DETAILED DESCRIPTION

In seismic surveying (marine or land-based seismic surveying), seismic sensors (e.g. geophones, accelerometers, etc.) are used to measure seismic data, such as displacement, velocity or acceleration data. Seismic sensors can include geophones, accelerometers, MEMS (microelectromechanical systems) sensors, or any other types of sensors that measure the translational motion of the surface at least in the vertical direction and possibly in one or both horizontal directions. A seismic sensor at the earth's surface can record the vectorial part of an elastic wavefield just below the free surface (land surface or seafloor, for example). When multicomponent sensors are deployed, the vector wavefields can be measured in multiple directions, such as three orthogonal directions (vertical Z, horizontal inline X, horizontal crossline Y). In marine seismic survey operations, hydrophone sensors can additionally be provided with the multicomponent vectorial sensors to measure pressure fluctuations in water.

Recorded seismic data can contain contributions from noise, including horizontal propagation noise such as ground-roll noise. Ground-roll noise refers to seismic waves produced by seismic sources, or other sources such as moving cars, engines, pump and natural phenomena such as wind and ocean waves, that travel generally horizontally along an earth surface towards seismic receivers. These horizontally travelling seismic waves, such as Rayleigh waves or Love waves, are undesirable components that can contaminate seismic data. Another type of ground-roll noise includes Scholte waves that propagate horizontally below a seafloor. Other types of horizontal noise include flexural waves or extensional waves. Yet another type of noise includes an air wave, which is a horizontal wave that propagates at the air-water interface in a marine survey context.

In the ensuing discussion, reference is made to ground-roll noise, and in particular, removal or attenuation of ground-roll noise from measured seismic data. However, in alternative implementations, similar noise attenuation techniques can be applied to eliminate or attenuate other types of noise.

Ground-roll noise is typically visible within a shot record (collected by one or more seismic sensors) as a high-amplitude, typically elliptically polarized, low-frequency, low-velocity, dispersive noise train. Ground-roll noise often distorts or masks reflection events containing information from deeper subsurface reflectors. To enhance accuracy in determining characteristics of a subterranean structure based on seismic data collected in a seismic survey operation, it is desirable to eliminate or attenuate contributions from noise, including ground-roll noise or another type of noise.

In accordance with some embodiments, to eliminate or attenuate a noise component (e.g. any one or more of the noise components noted above), rotation data is combined with seismic data to eliminate or attenuate the noise component from the seismic data. In some implementations, rotation data can be measured by a rotational sensor. The rotation data refers to the rotational component of the seismic wavefield. As an example, one type of rotational sensor is the R−1 rotational sensor from Eentec, located in St. Louis, Mo. In other examples, other rotational sensors can be used.

Rotation data refers to a rate of a rotation (or change in rotation over time) about a horizontal axis, such as about the horizontal inline axis (X) and/or about the horizontal crossline axis (Y) and/or about the vertical axis (Z). In the marine seismic surveying context, the inline axis X refers to the axis that is generally parallel to the direction of motion of a streamer of survey sensors. The crossline axis Y is generally orthogonal to the inline axis X. The vertical axis Z is generally orthogonal to both X and Y. In the land-based seismic surveying context, the inline axis X can be selected to be any horizontal direction, while the crossline axis Y can be any axis that is generally orthogonal to X.

In some examples, a rotational sensor can be a multi-component rotational sensor that is able to provide measurements of rotation rates around multiple orthogonal axes (e.g. R_{X} about the inline axis X, R_{Y} about the crossline axis Y, and R_{Z} about the vertical axis Z). Generally, Rᵢ represents rotation data, where the subscript i represents the axis (X, Y, or Z) about which the rotation data is measured.

In alternative implementations, instead of using a rotational sensor to measure rotation data, the rotation data can be derived from measurements (referred to as “vectorial data”) of at least two closely-spaced apart seismic sensors used for measuring a seismic wavefield component along a particular direction, such as the vertical direction Z. Rotation data can be derived from the vectorial data of closely-based seismic sensors that are within some predefined distance of each other (discussed further below).

In some examples, the rotation data can be obtained in two orthogonal components. A first component is in the direction towards the source (rotation around the crossline axis, Y, in the inline-vertical plane, X-Z plane), and the second component is perpendicular to the first component (rotation around the inline axis, X in the crossline-vertical plane, Y-Z plane). In such geometry, the rotation in the X-Z plane is dominated by direct ground-roll noise while the component perpendicular will be dominated by side scattered ground-roll, which may improve the noise suppression using adaptive subtraction.

As sources may be located at any distance and azimuth from the rotation sensor location, the first component may not always be pointing towards the source while the second component may not be perpendicular to the source-receiver direction. In these situations, the following pre-processing may be applied that mathematically rotates both components towards the geometry described above. Such a process is referred to as vector rotation, which provides data different from measured rotation data to which the vector rotation is applied. The measured rotation components R_{X} and R_{Y} are multiplied with a matrix that is function of an angle between the X axis of the rotation sensor, and the direction of the source as seen from the rotation sensor.

$$[ \begin{matrix}{R}_{I} \\ {R}_{C}\end{matrix} ] = [ \begin{matrix}cos θ & - sin θ \\ sin θ & cos θ\end{matrix} ] \cdot [ \begin{matrix}{R}_{y} \\ {R}_{x}\end{matrix} ] .$$

The foregoing operation results in the desired rotation in the X-Z plane (R_{C}) and Y-Z plane (R_{I}).

Another optional pre-processing step is the time (t) integration of the rotation data. This step can be mathematically described as:

Rₓ′=∫ₜ₌₀^{t=end}Rₓdt.

The foregoing time integration of the rotation data results in a phase shift in the waveform and shift of its spectrum towards lower frequencies.

Rotation data (e.g. R_{X} and/or R_{Y}), whether measured by a rotational sensor or derived from seismic sensor measurements, can be used as a noise reference model to clean seismic data (e.g. vertical seismic data). In some implementations, adaptive filtering techniques (e.g. adaptive subtraction techniques) can be applied to use rotation data in performing noise attenuation in recorded seismic data. An adaptive filtering technique refers to a technique in which one or more filters are derived, where the filters are combined with the recorded seismic data to modify the seismic data, such as to remove noise component(s).

In some implementations, adaptive filtering techniques can be used to perform noise attenuation using rotation data. In some examples, an adaptive filtering technique is an adaptive subtraction technique, such as an adaptive subtraction technique based on techniques described in U.S. Pat. No. 5,971,095, which is hereby incorporated by reference. U.S. Pat. No. 5,971,095 describes adaptive subtraction techniques that use several components as noise references to extract the ground-roll noise from the Z seismic data in sliding time-offset windows. Note, however, that the adaptive subtraction techniques of U.S. Pat. No. 5,971,095 do not involve use of rotation data. In other implementations, other adaptive filtering techniques can be applied.

Rotation data can be used by itself for noise attenuation, or alternatively, noise suppression based on rotation data can be combined with other types of noise attenuation techniques. Various example categories of noise attenuation techniques exist. A first category noise attenuation techniques involves exploiting the frequency content difference between noise signals (which are in the lower frequency range) and seismic signals (which are in the higher frequency range). Another category of noise attenuation techniques involves exploiting the velocity difference between noise signals (which generally have lower velocities) and seismic signals (which generally have higher velocities). Yet another category of noise attenuation techniques involves exploiting data polarizations—for example, ground-roll noise typically has an elliptical polarization attribute, while seismic signals typically have linear polarization. The difference in polarizations can be used to separate noise from seismic data.

Yet another category of noise attenuation techniques involves using a horizontal signal component as a noise reference with no assumptions about data polarization. The horizontal signal component contains less reflection signal energy (reflection signal energy refers to the energy associated with reflection of seismic waves from subterranean elements. As a result, the horizontal signal component provides a good noise reference that can be used to clean the vertical signal component (which is more sensitive to presence of subterranean elements) using various types of adaptive filtering techniques.

As an example of a noise attenuation technique based on using a horizontal signal component as a noise reference, divergence data from a divergence sensor can be used. The divergence data can be combined with seismic data to perform noise attenuation in the seismic data. In some implementations, the divergence sensor is formed using a container filled with a material in which a pressure sensor (e.g. a hydrophone) is provided. The material in which the pressure sensor is immersed can be a liquid, a gel, or a solid such as sand or plastic. The pressure sensor in such an arrangement is able to record a seismic divergence response of a subsurface, where this seismic divergence constitutes the horizontal signal component.

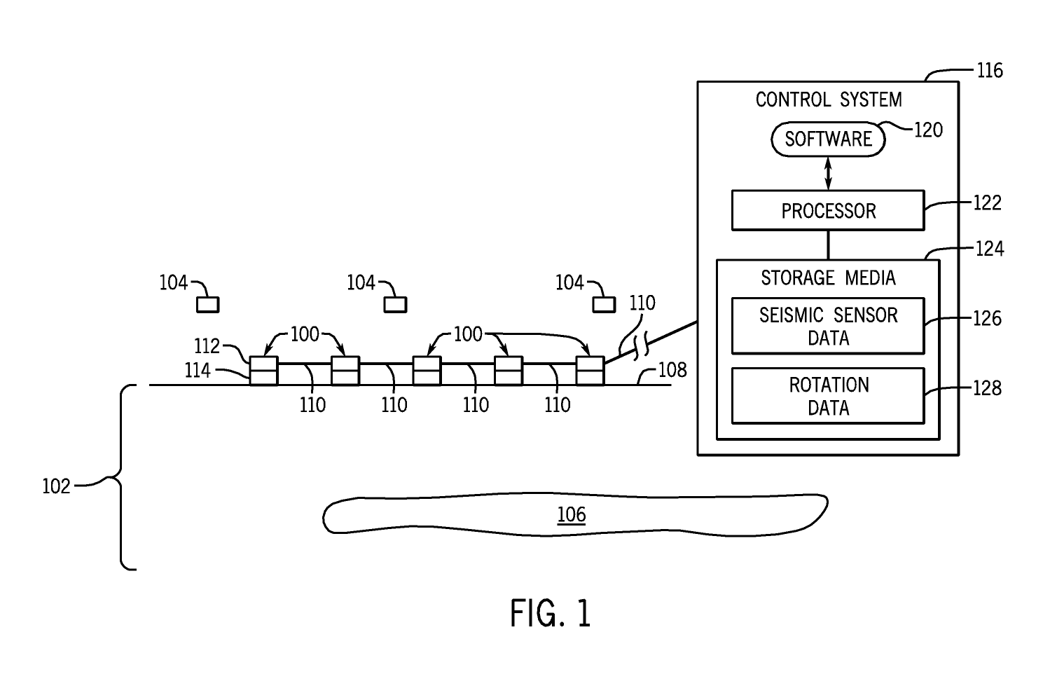

FIG. 1 is a schematic diagram of an arrangement of sensor assemblies (sensor stations) 100 that are used for land-based seismic surveying. Note that techniques or mechanisms can also be applied in marine surveying arrangements. The sensor assemblies 100 are deployed on a ground surface 108 (in a row or in an array). A sensor assembly 100 being “on” a ground surface means that the sensor assembly 100 is either provided on and over the ground surface, or buried (fully or partially) underneath the ground surface such that the sensor assembly 100 is within approximately 10 meters of the ground surface, although in some embodiments, other spacing may be appropriate depending on the equipment being used. The ground surface 108 is above a subterranean structure 102 that contains at least one subterranean element 106 of interest (e.g. hydrocarbon reservoir, freshwater aquifer, gas injection zone, etc.). One or more seismic sources 104, which can be vibrators, air guns, explosive devices, and so forth, are deployed in a survey field in which the sensor assemblies 100 are located. The one or more seismic sources 104 are also provided on the ground surface 108.

Activation of the seismic sources 104 causes seismic waves to be propagated into the subterranean structure 102. Alternatively, instead of using controlled seismic sources as noted above to provide controlled source or active surveys, techniques according to some implementations can be used in the context of passive surveys. Passive surveys use the sensor assemblies 100 to perform one or more of the following: (micro)earthquake monitoring; hydro-frac monitoring where microearthquakes are observed due to rock failure caused by fluids that are actively injected into the subsurface (such as to perform subterranean fracturing); and so forth.

Seismic waves reflected from the subterranean structure 102 (and from the subterranean element 106 of interest) are propagated upwardly towards the sensor assemblies 100. Seismic sensors 112 (e.g. geophones, accelerometers, etc.) in the corresponding sensor assemblies 100 measure the seismic waves reflected from the subterranean structure 102. Moreover, in accordance with various embodiments, the sensor assemblies 100 further include rotational sensors 114 that are designed to measure rotation data.

Although a sensor assembly 100 is depicted as including both a seismic sensor 112 and a rotational sensor 114, note that in alternative implementations, the seismic sensors 112 and rotational sensors 114 can be included in separate sensor assemblies. As yet another alternative, rotational sensors 114 can be omitted, with rotation data derived from measurements from at least two closely-spaced apart seismic sensors 112 (spaced apart by less than a predefined distance or offset).

In further alternative implementations, other types of sensors can also be included in the sensor assemblies 100, including divergence sensors as discussed above. As noted above, divergence data from the divergence sensors can be used to provide a noise reference model for performing noise attenuation. In such implementations, the divergence data and rotation data can be combined with seismic data for noise attenuation in the seismic data. As yet a further alternative, another type of noise attenuation technique can be combined with the use of rotation data to suppress noise in seismic data.

In some implementations, the sensor assemblies 100 are interconnected by an electrical cable 110 to a control system 116. Alternatively, instead of connecting the sensor assemblies 100 by the electrical cable 110, the sensor assemblies 100 can communicate wirelessly with the control system 116. In some examples, intermediate routers or concentrators may be provided at intermediate points of the network of sensor assemblies 100 to enable communication between the sensor assemblies 100 and the control system 116.

The control system 116 shown in FIG. 1 further includes processing software 120 that is executable on one or more processors 122. The processor(s) 122 is (are) connected to storage media 124 (e.g. one or more disk-based storage devices and/or one or more memory devices). In the example of FIG. 1, the storage media 124 is used to store seismic data 126 communicated from the seismic sensors 112 of the sensor assemblies 100 to the controller 116, and to store rotation data 128 communicated from the rotational sensors 114 or derived from closely-spaced apart seismic sensors. The storage media 124 can also be used to store divergence data (not shown) in implementations where divergence sensors are used.

In yet further implementations, the storage media 124 can also be used to store horizontal translational data (X and/or Y translational data). Translational data in the X and Y directions are also referred to as horizontal vectorial components, represented as U_{X} and/or U_{Y}, respectively. The U_{X} and/or U_{Y} data (which can be measured by respective X and Y components of the seismic sensors 112) can also be used to represent noise for purposes of noise attenuation. The U_{X} and/or U_{Y} data can be combined with the rotation data, and possibly, with divergence data, for noise attenuation.

In operation, the processing software 120 is used to process the seismic data 126 and the rotation data 128. The rotation data 128 is combined with the seismic data 126, using techniques discussed further below, to attenuate noise in the seismic data 126 (to produce a cleansed version of the seismic data). The processing software 120 can then produce an output to characterize the subterranean structure 102 based on the cleansed seismic data 126.

As noted above, according to alternative implementations, the processing software 120 can combine the rotation data 128, along with divergence data and/or X and/or Y translational data (horizontal vectorial components U_{X} and/or U_{Y}), with the seismic data 126 to cleanse the seismic data.

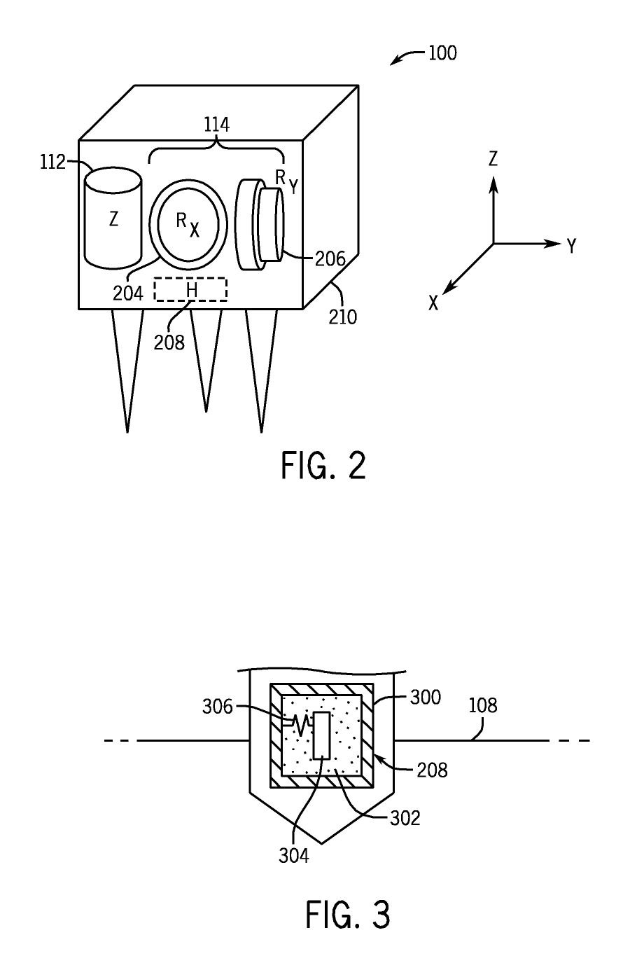

FIG. 2 illustrates an example sensor assembly (or sensor station) 100, according to some examples. The sensor assembly 100 can include a seismic sensor 112, which can be a particle motion sensor (e.g. geophone or accelerometer) to sense particle velocity along a particular axis, such as the Z axis. In addition, the sensor assembly 100 includes a first rotational sensor 204 that is oriented to measure a crossline rate of rotation (R_{X}) about the inline axis (X axis), and a second rotational sensor 206 that is oriented to measure an inline rate of rotation (R_{Y}) about the crossline axis (Y axis). In other examples, the sensor assembly 100 can include just one of the rotational sensors 204 and 206. In further alternative examples where rotation data is derived from Z seismic data measured by closely-spaced apart seismic sensors, both the sensors 204 and 206 can be omitted. The sensor assembly 100 has a housing 210 that contains the sensors 112, 204, and 206.

The sensor assembly 100 further includes (in dashed profile) a divergence sensor 208, which can be included in some examples of the sensor assembly 100, but can be omitted in other examples.

An example of a divergence sensor 208 is shown in FIG. 3. The divergence sensor 208 has a closed container 300 that is sealed. The container 300 contains a volume of liquid 302 (or other material such as a gel or a solid such as sand or plastic) inside the container 300. Moreover, the container 300 contains a hydrophone 304 (or other type of pressure sensor) that is immersed in the liquid 302 (or other material). The hydrophone 304 is mechanically decoupled from the walls of the container 300. As a result, the hydrophone 304 is sensitive to just acoustic waves that are induced into the liquid 302 through the walls of the container 300. To maintain a fixed position, the hydrophone 304 is attached by a coupling mechanism 306 that dampens propagation of acoustic waves through the coupling mechanism 306. Examples of the liquid 302 include the following: kerosene, mineral oil, vegetable oil, silicone oil, and water. In other examples, other types of liquids or another material can be used.

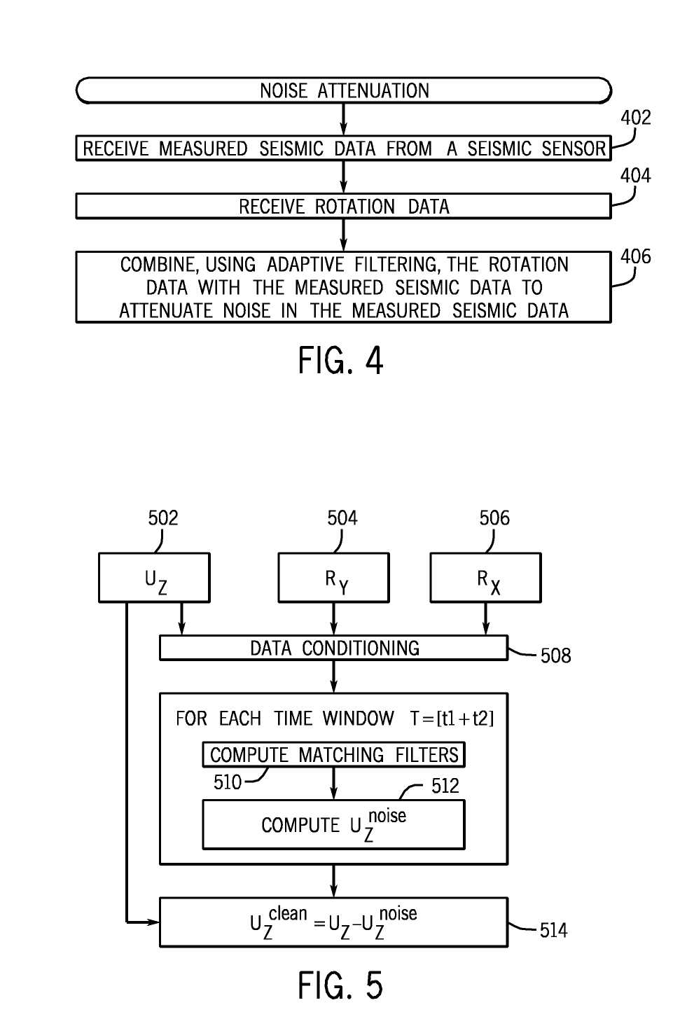

FIG. 4 is a flow diagram of a process of noise attenuation based on rotation data, in accordance with some embodiments. In some implementations, the process of FIG. 4 can be performed by the processing software 120 of FIG. 1, or by some other entity.

The process of FIG. 4 receives (at 402) measured seismic data from a seismic sensor (e.g. 112 in FIG. 1). The process of FIG. 4 also receives (at 404) rotation data, which can be measured by a rotational sensor (e.g. 204 and/or 206 in FIG. 2) or can be derived from measurements (e.g. vertical vectorial fields) of closely-spaced seismic sensors.

The process then combines (at 406), using adaptive filtering, the rotation data with the measured seismic data to attenuate a noise component in the measured seismic data. Although reference has been made to measured seismic data from an individual seismic sensor, it is noted that in alternative implementations, the noise attenuation can be applied to measured seismic data from multiple seismic sensors.

In the foregoing, the noise reference is represented by the rotation data. However, in other implementations, the noise reference can also be represented by other types of data, including divergence data, vectorial (translational) data, and so forth, that is representative of the noise component that is to be removed or attenuated from received seismic data, e.g. the vertical component of a velocity wavefield. The adaptive filtering technique applied at 406 can use predominately the component that locally correlates the best with input noisy data. In some implementations, the adaptive filtering is a time-offset variant process (the adaptive filtering is applied in sliding time windows), and thus the adaptive filtering can attenuate multi-azimuth scattered events. Note that the adaptive filtering technique is eventually time-invariant for certain geometries and near-surface conditions.

The adaptive filtering can involve locally estimating the A_{X}(T) and A_{Y}(T) operators (which are referred to as “matching filters”) that reduce or minimize (in the least square sense, for example) the noise on input seismic data (e.g. U_{Z}, which represents vertical seismic data) over a given time window. Considering an individual time window, the cleaned/output U_{Z} data is obtained by:

U_{Z}(T)−A_{X}(T)U_{X}−A_{Y}(T)U_{Y}, (Eq. 1)

where T is the considered time range (window), and A_{X}(T) and A_{Y}(T) are computed by minimizing |U_{Z}(T)−A_{X}(T)U_{X}−A_{Y}(T)U_{Y}|² in the least square sense, for example. Further example details regarding calculating the matching filters are provided in U.S. Pat. No. 5,971,095, referenced above. The matching filters can be frequency dependent, or in some embodiments, not frequency dependent.

The main input parameters are the size of the window, T, and the length of the matching filters, A_{X}(T) and A_{Y}(T). In some embodiments, the use of short time windows and long filters are useful for noise removal (aggressive filtering).

Note also that the A_{X}(T) and A_{Y}(T) matching filters relate to the apparent polarization of a signal in an individual window. In the following discussion, reference is made to vectorial polarization for the Z versus X (or Y) relationship, and rotational polarization for the Z versus R_{X} (or R_{Y}) relationship.

As noted above, some embodiments involve the use of at least one rotational component as a noise reference to locally remove the undesirable noise from (typically) the Z component. “Locally” removing undesirable noise means that the noise attenuation techniques do not have to employ data from array(s) of sources or sensors—instead, noise attenuation can be performed using measurements from sensors of an individual sensor station (e.g. an individual sensor station 100). As a result, the sensor station 100 would not have to be deployed in an array or other pattern of sensor stations to enable noise attenuation. In an environment that includes one or more obstructions that can disturb a regular pattern of sensor assemblies, provision of rotational sensor(s) in an individual sensor station (that also contains a seismic sensor) allows noise attenuation locally at the individual sensor station even without a regular pattern of sensor stations. In this way, relatively large spacings between sensor stations can be provided, where sensor stations can be spaced apart from each other by a distance larger than half a shortest wavelength of noise.

The following describes the use of two noise references (rotation data R_{X} and R_{Y}) for adaptive noise subtraction from seismic data along the Z axis. However, adaptive noise subtraction is not limited to two references only or to the Z component. For example, one may use five (or more) references (horizontal vectorial data U_{X} and/or U_{Y}, rotation data R_{X}, R_{Y}, and the divergence data H, or any combination of the foregoing).

The ensuing discussion makes reference to noise attenuation techniques that use rotational sensors that measure at least the component of the rotation field of the earth surface around the horizontal axes (R_{X} and R_{Y}), and in some embodiments, around the vertical axis (R_{Z}). It can be assumed that the rotational sensor impulse response is known and properly compensated for—in other words, the rotation data is considered to be properly calibrated with respect to the seismic data. However, in other examples, calibration of the rotation data with respect to the seismic data does not have to be performed.

Taking into account boundary conditions (free surface or land surface for land-based seismic surveying or seafloor for ocean-bottom system or ocean-bottom cable seismic surveying), it can be shown that the time differentiated crossline rotation rate data R_{Y} is equal (or proportional if not properly calibrated) to the inline spatial derivative of the vertical seismic field U_{Z}:

$$\frac{\partial {R}_{Y}}{\partial t} = \frac{\partial {U}_{Z}}{\partial x} = \frac{{U}_{Z} ( x + \partial x / 2 , y ) - {U}_{Z} ( x - \partial x / 2 , y )}{\partial x} . \qquad ( Eq . 2 )$$

The time differentiated inline rotation data R_{X} is equal (or proportional if not properly calibrated) to the crossline spatial derivative of the vertical seismic field U_{Z}:

$$\frac{\partial {R}_{X}}{\partial t} = \frac{\partial {U}_{Z}}{\partial y} = \frac{{U}_{Z} ( x , y + \partial y / 2 ) - {U}_{Z} ( x , y - \partial y / 2 )}{\partial y} . \qquad ( Eq . 3 )$$

In Eqs. 2 and 3, δx and δy are relatively small distances compared to the dominant seismic wavelength, but vary according to the needs of the specific situation as will be understood by those with skill in the art. Eqs. 2 and 3 show that the rotation measurement at the free surface is proportional to the spatial gradient of the vertical component of the measured seismic data. Therefore, if rotational sensors are not available, an estimate of the rotation data can be made using two or more conventional seismic sensors closely spaced together (to be within some predefined distance or offset). This spacing is typically smaller than a quarter of the wavelength of interest and therefore smaller than the Nyquist wavenumber of half the wavelength of interest, which is usually the required spatial sampling for the seismic waves being measured. Note that Eqs. 3 and 2 can also be rewritten, respectively, as:

R_{X}=p_{Y}U_{Z}, (Eq. 4)

R_{Y}=p_{X}U_{Z}, (Eq. 5)

where p_{X} and p_{Y} are the inline and crossline horizontal slownesses (inverse of the apparent velocities in the X and Y directions respectively).

Eqs. 4 and 5 show that the rotational components (R_{X} and R_{Y}) are slowness-scaled versions of the vertical seismic data (scaled by p_{X} and p_{Y}, respectively). These relations do not depend on the considered type of wave (e.g. P wave, S wave, or Rayleigh wave). Therefore, at least when sensors are properly calibrated together, the rotation data is in phase with U_{Z} for both body waves and surface waves, in contrast to the horizontal geophone data which are in phase for body waves (linear polarization) but phase shifted for surface waves (elliptical polarization).

Eqs. 4 and 5 also show that, on the rotation data, in comparison to the vertical seismic data, the reflection signal (signal reflected from the subterranean structures) is considerably reduced in amplitude (especially the nearly vertically propagating P waves, which have relatively small horizontal slownesses), in contrast to the slower propagating ground-roll (which has higher horizontal slowness). In other words, on the rotation data (compared to vertical seismic data), the ratio of reflected wave signals to ground-roll noise is considerably reduced, which means that the rotation data contains predominately ground-roll events and therefore can be used as a noise reference models for adaptive subtraction.

The latter statement is also valid for the horizontal vectorial component(s), U_{X} and/or U_{Y} (they also contain predominately noise), but Eqs. 4 and 5 also show that, in contrast to U_{X} and/or U_{Y}, the rotation data is not perturbed by undesirable S waves (that do not correlate with U_{Z}). As already mentioned, the rotational polarization depends on the horizontal slowness, but not on the type of wave as it is the case considering the vectorial polarization. For example, the X versus Z polarization is high for S waves (mainly horizontally polarized) and small for P waves (mainly vertically polarized).

Moreover, the vectorial polarization of the ground-roll noise is a function of the near-surface properties (up to several hundreds of meter depth for low frequencies). This makes vectorial polarization relatively complex, which is challenging for noise attenuation based on adaptive subtraction.

In contrast to the local vectorial polarization that depends on the horizontal slowness, the wave type and the near-surface structure, the local rotational polarization depends solely on the horizontal slowness. Because the rotational polarization is less complex, noise attenuation based on rotation data can provide better results as compared to noise attenuation based on horizontal vectorial data (assuming the same parameters for adaptive subtraction are used). Alternatively, one may obtain the same quality of noise removal with rotation data, but using larger sliding windows, and/or shorter filters (even scalars), therefore improving the efficiency of the noise attenuation technique in terms of computation time.

FIG. 5 is a flow diagram of a process for noise attenuation that uses rotation data as noise references, according to further implementations. The process of FIG. 5 can also be performed by the processing software 120 of FIG. 1, or by another entity. The input data to the noise attenuation process of FIG. 5 includes vertical seismic data U_{Z} (502) and rotation data R_{X} (504) and R_{Y} (506). Note that in some implementations, two noise reference components (R_{X} and R_{Y}) are used, which may be useful when the near-surface structure is relatively complex (such as a near-surface structure that exhibits three-dimensional scattering). However, with a laterally homogeneous near-surface structure, for example, one may use a single rotational component as a noise reference, typically the rotational component that contains most of the noise, such as the R_{Y} data for inline shots or the rotation data that is perpendicular to the source-receiver azimuth.

The process of FIG. 5 can apply (at 508) data conditioning, which can include attenuating the seismic data (reflection signal) from the rotation data to focus on the ground-roll noise for the adaptive subtraction process. For example, the data conditioning can include muting the data outside a noise cone in the time-offset domain. Also or alternatively, the data conditioning can apply low-pass frequency filtering to remove a high-frequency signal, and can apply a bandpass filter that limits the bandwidth of the noise reference. Additionally or alternatively, the data conditioning can perform correction of impulse responses of seismic sensors, and, if possible (when sensor arrays are available), the data conditioning can apply tau-p (where tau is intercept time, and p is horizontal slowness) or f−k (where f represents frequency and k represents wavenumber) filtering (to attenuate fast propagating reflections). Other examples of data conditioning are time integration and vector rotation of the rotation towards the source-rotation sensor direction. The objective of the data conditioning stage is to improve the noise correlation between the components. In some implementations, the data conditioning (508) can be omitted.

As noted above, the adaptive subtraction technique according to some implementations is a time-offset variant process in which the adaptive subtraction is applied in sliding time windows. As shown in FIG. 5, each of the time windows is represented as T=[t1, t2], where t1 represents the beginning of the time window T, and t2 represents the end of the time window T. For each time window T, the process of FIG. 5 computes (at 510) matching filters A_{X}(T) and A_{Y}(T). As noted above, the matching filters are estimated based on minimizing (in the least square sense, for example) the noise on input seismic data over a given time window. More specifically, the matching filters A_{X}(T) and A_{Y}(T) are computed by minimizing |U_{Z}(T)−A_{X}(T)U_{X}−A_{Y}(T)U_{Y}|² in the least square sense, in some examples.

Once the matching filters A_{X}(T) and A_{Y}(T) are calculated, they can be combined (at 514) with the rotation data, R_{X}(T) and R_{Y}(T), to compute a local Z noise estimate, U_{Z}^{noise}(T). More specifically, the local Z estimate, U_{Z}^{noise}(T), is computed as follows:

U_{Z}^{noise}(T)=A_{Y}(T)R_{Y}(T)+A_{Y}(T)R_{X}(T).

The computed local Z noise estimate, U_{Z}^{noise}(T), is then subtracted (at 514) from the seismic data U_{Z}, as follows:

U_{Z}^{clean}=U_{Z}−U_{Z}^{noise}.

The FIG. 5 approach does not involve sensor calibration and can be applied locally, i.e. there is no need for an array of sources or receivers. The adaptive nature of the process compensates for the fact that the local matching filters are slowness dependent. It may also compensate for the eventual calibration and orientation issues.

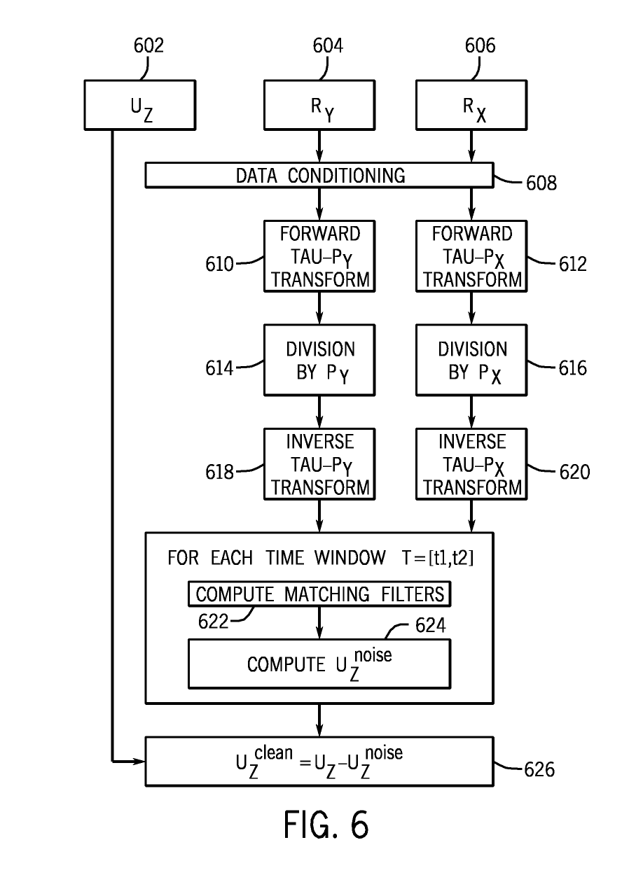

Alternatively, when dense array(s) of receivers are available, the data conditioning (508) may be extended to further improve the global correlation between the components (to make the rotational polarization even less complex). For instance, compensation for the slowness dependency can be performed by pre-processing in the tau-p domain (or equivalently in the f−k domain) such that the adaptive subtraction stage can be simplified. Such a procedure is illustrated in FIG. 6.

The input data to the noise attenuation process of FIG. 6 includes vertical seismic data U_{Z} (602) and rotation data R_{X} (604) and R_{Y} (606). Data conditioning is then performed (at 608), which seeks to attenuate the reflection energy in the rotation data to mainly focus on the ground-roll noise (as with the FIG. 5 approach above).

However, in the FIG. 6 process, the rotational components (R_{X} and R_{Y}) are p-scaled in the tau-p domain (where tau is intercept time, and p is horizontal slowness) to directly match the noise component in the vertical seismic data U_{Z}. The p-scaling (pre-processing in the tau-p domain) includes tasks 610, 612, 614, 616, 618, and 620 in FIG. 6. The process transforms (at 610, 612) the rotation data (R_{X} and R_{Y}, respectively) by performing a forward tau-p transformation, where the rotation data is transformed into the tau-p domain (i.e. tau-p_{X} and tau-p_{Y} for R_{X} and R_{Y} respectively). The transformed tau-p data are then divided (at 614, 616) by the known p_{X} (slowness in X) and p_{Y} (slowness in Y), respectively. Then, inverse tau-p transform is performed (at 618, 620). In such implementations, the time-variant adaptive subtraction process only seeks to identify the rotational component that best matches the noise on U_{Z}, but does not seek to correct the p-dependency (slowness dependency). This may improve the quality of the filtering or alternatively reduce the computation time by allowing the use of larger sliding time window and/or shorter matching filters.

Note that in the tau-p pre-processing (610-620 in FIG. 6), only the p range containing the noise has to be inverse transformed. Therefore, there is no instability issue (division by p=0) because the process is only interested in relatively high p values (corresponding to slow ground-roll noise).

The remaining tasks (622, 624, and 626) of FIG. 6 are the same as corresponding tasks 510, 512, and 514, respectively, in FIG. 5.

The processes described in FIGS. 4-6 can be implemented with machine-readable instructions (such as the processing software 120 in FIG. 1). The machine-readable instructions are loaded for execution on a processor or multiple processors (e.g. 122 in FIG. 1). A processor can include a microprocessor, microcontroller, processor module or subsystem, programmable integrated circuit, programmable gate array, or another control or computing device.

Data and instructions are stored in respective storage devices, which are implemented as one or more computer-readable or machine-readable storage media. The storage media include different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; optical media such as compact disks (CDs) or digital video disks (DVDs); r other types of storage devices. Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

In the foregoing description, numerous details are set forth to provide an understanding of the subject disclosed herein. However, implementations may be practiced without some or all of these details. Other implementations may include modifications and variations from the details discussed above. It is intended that the appended claims cover such modifications and variations.

What is claimed is:

1. A method comprising:
receiving, from a seismic sensor, measured seismic data;
receiving rotation data representing rotation with respect to at least one particular axis; and
combining, using adaptive filtering, the rotation data with the measured seismic data to attenuate at least a portion of a noise component from the measured seismic data.

2. The method of claim 1, wherein receiving the rotation data comprises receiving the rotation data measured by a rotational sensor.

3. The method of claim 2, wherein the combining combines the rotation data individually received from the rotational sensor with the seismic data individually received from the seismic sensor to attenuate at least the portion of the noise component.

4. The method of claim 1, wherein receiving the rotation data comprises receiving the rotation data that is estimated from measurements of at least two seismic sensors that are spaced apart by less than a predetermined distance.

5. The method of claim 1, wherein receiving the rotation data comprises receiving a rotation component with respect to a first axis and a rotation component with respect to a second axis generally perpendicular to the first axis.

6. The method of claim 1, wherein receiving the rotation data comprises receiving the rotation data based on measurement of a second sensor, where:
the second sensor is co-located with the seismic sensor within a housing, or
the second sensor is spaced from the seismic sensor by less than a predetermined distance.

7. The method of claim 1, wherein the adaptive filtering comprises using the rotation data to provide a noise reference for adaptive subtraction from the seismic data.

8. The method of claim 7, wherein the adaptive subtraction is time-offset variant.

9. The method of claim 7, wherein the adaptive subtraction is frequency dependent.

10. The method of claim 1, further comprising:
receiving divergence data from a divergence sensor,
wherein the adaptive filtering further combines the divergence data and the rotation data with the seismic data to attenuate at least the portion of the noise component.

11. The method of claim 1, further comprising:
receiving horizontal component seismic data,
wherein the adaptive filtering further combines the horizontal component seismic data and the rotation data with the seismic data to attenuate at least the portion of the noise component.

12. The method of claim 1, wherein the seismic data is measured along the vertical axis and includes vertical component seismic data, and
wherein the adaptive filtering further combines one or more components of the rotation data measured around a horizontal axis with the vertical component seismic data to attenuate at least the portion of the noise component.

13. An article comprising at least one machine-readable storage medium storing instructions that upon execution cause a system having a processor to:
receive seismic data measured by a seismic sensor;
receive rotation data representing rotation with respect to at least one particular axis; and
combine, using adaptive filtering, the received seismic data and the received rotation data to attenuate at least a portion of a noise component from the received seismic data.

14. The article of claim 13, wherein the noise component comprises a horizontally travelling wave.

15. The article of claim 13, wherein the seismic data includes one or more of a vectorial component in a vertical direction, a vectorial component in a first horizontal direction, and a vectorial component in a second horizontal direction that is generally perpendicular to the first horizontal direction, and
wherein the rotation data includes one or more of a first rotation component with respect to the vertical direction, a second rotation component with respect to the first horizontal direction, and a third rotation component with respect to the second horizontal direction.

16. The article of claim 13, wherein the adaptive filtering includes computing at least one matching filter that is to attenuate, in a least square sense, noise in the seismic data over a given time window.

17. The article of claim 13, further comprising applying data conditioning to the rotation data to improve noise correlation.

18. The article of claim 13, wherein the seismic sensor is part of an individual sensor station that also includes a rotational sensor to measure the rotation data, and wherein combining the received seismic data and the rotation data to attenuate at least the portion of the noise component is based on the seismic data and rotation data from just the individual sensor station.

19. The article of claim 18, wherein attenuation of at least the portion of the noise component based on the seismic data and the rotation data from just the individual sensor station allows the noise attenuation to be performed without having to receive seismic data from other sensor stations that are part of a pattern of sensor stations.

20. The article of claim 18, wherein the sensor station is spaced apart from another sensor station by a distance larger than have a shortest wavelength of noise.

21. A system comprising:
a storage medium to store seismic data measured by a seismic sensor and rotation data; and
at least one processor to:
apply adaptive filtering to combine the seismic data and the rotation data to remove at least a portion of a noise component in the seismic data.

22. The system of claim 21, wherein the rotation data includes rotation fields with respect to plural horizontal directions.
